(19) United States
(12) Patent Application Publication
(10) Pub. No.: US 2013/0152809 A1
(43) Pub. Date: Jun. 20, 2013

(54) RESIN COMPOSITION FOR LASER ENGRAVING, FLEXOGRAPHIC PRINTING PLATE PRECURSOR AND PROCESS FOR PRODUCING SAME, AND FLEXOGRAPHIC PRINTING PLATE AND PROCESS FOR MAKING SAME

(71) Applicant: FUJIFILM Corporation, Tokyo (JP)

(72) Inventor: Kenta USHIJIMA, Haibara-gun (JP)

(73) Assignee: FUJIFILM CORPORATION, Tokyo (JP)

(21) Appl. No.: 13/711,264

(22) Filed: Dec. 11, 2012

(30) Foreign Application Priority Data
Dec. 15, 2011 (JP) 2011-274696

(51) Int. Cl. B41N 1/06

(52) U.S. Cl. CPC B41N 1/06; Y10S 977/773; B82Y 30/00
USPC 101/395; 523/466; 101/401.1; 977/773

(57) ABSTRACT

A resin composition for laser engraving that comprises (Component A) an epoxy resin; (Component B) an epoxy resin curing agent; and (Component C) a silica, Component B comprising an amine curing agent having an amine value of no greater than 0.01 eq/g or an acid anhydride curing agent having an acid anhydride value of no greater than 0.0050 eq/g.

### TECHNICAL FIELD

The present invention relates to a resin composition for laser engraving, a flexographic printing plate precursor and a process for producing the same, and a flexographic printing plate and a process for making the same.

### BACKGROUND ART

As a process for forming a printing plate by forming asperities in a photosensitive resin layer layered on a surface of a support, a method in which a relief-forming layer formed using a photosensitive composition is exposed to UV light through an original image film to thus selectively cure an image area, and an uncured area is removed using a developer, the so-called ‘analogue plate making’, is well known.

A flexographic printing plate is a letterpress printing plate having a relief layer with asperities, and such a relief layer with asperities is obtained by patterning a relief-forming layer comprising a photosensitive composition containing as a main component, for example, an elastomeric polymer such as a synthetic rubber, a resin such as a thermoplastic resin, or a mixture of a resin and a plasticizer, thus forming asperities.

As a flexographic printing plate, those described in JP-A-2009-262370 (JP-A denotes a Japanese unexamined patent application publication), Japanese Patent No. 2846954, Japanese Patent No. 4375705, or JP-T-2011-510839 (JP-T denotes a published Japanese translation of a PCT application) are known.

### DISCLOSURE OF PRESENT INVENTION

### Problems That the Present Invention is to Solve

It is an object of the present invention to provide a resin composition for laser engraving that can give a flexographic printing plate having excellent engraving residue rinsing properties and ink transfer properties, a flexographic printing plate precursor and a process for producing same employing the resin composition for laser engraving, and a flexographic printing plate and a process for making same.

### Means for Solving the Problems

The above-mentioned object of the present invention has been attained by solution means <1> and <15> to <19> below. They are described below together with <2> to <14>, which are preferred embodiments.
<1> A resin composition for laser engraving, comprising (Component A) an epoxy resin, (Component B) an epoxy resin curing agent, and (Component C) a silica, Component B comprising an amine curing agent having an amine value of no greater than 0.01 eq/g or an acid anhydride curing agent having an acid anhydride value of no greater than 0.0050 eq/g,
<2> the resin composition for laser engraving according to <1> above, wherein the amine curing agent is a diamine compound having a polyalkyleneoxy chain,
<3> the resin composition for laser engraving according to <1> above, wherein the acid anhydride curing agent is an alkylsuccinic anhydride, an alkenylsuccinic anhydride, or an aliphatic dibasic acid polyanhydride,
<4> the resin composition for laser engraving according to <2> above, wherein the acid anhydride curing agent is an alkylsuccinic anhydride, an alkenylsuccinic anhydride, or an aliphatic dibasic acid polyanhydride,
<5> the resin composition for laser engraving according to <1> above, wherein Component B is a diamine represented by Formula (1),

H₂N—R¹R²—OₙR³—NH₂ (1)

wherein in Formula (1), R¹ denotes a single bond or a divalent hydrocarbon group having 1 to 20 carbons, the R²s independently denote a divalent hydrocarbon group having 2 to 20 carbons, R³ denotes a divalent hydrocarbon group having 2 to 20 carbons, and n denotes an integer of 1 or greater, the diamine represented by Formula (1) having an amine value of no greater than 0.01 eq/g due to the structures of R¹ to R³ and the number denoted by n,
<6> the resin composition for laser engraving according to <1> above, wherein Component B is an alkenylsuccinic anhydride or an aliphatic dibasic acid polyanhydride,
<7> the resin composition for laser engraving according to <1> or <6> above, wherein Component B is an anhydride represented by Formula (2),

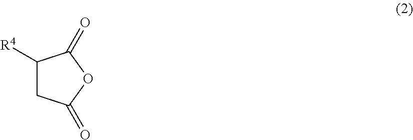

wherein in Formula (2), R⁴ denotes a hydrocarbon group having 8 to 30 carbons,
<8> the resin composition for laser engraving according to <1> or <6> above, wherein Component B is an aliphatic dibasic acid polyanhydride represented by Formula (3),

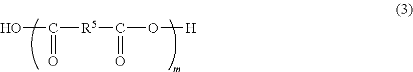

wherein in Formula (3), R⁵ denotes a divalent hydrocarbon group having 9 to 30 carbons and m denotes an integer of 2 or greater,
<9> the resin composition for laser engraving according to <1> above, wherein Component B is a diamine represented by Formula (1), an anhydride represented by Formula (2), or an aliphatic dibasic acid polyanhydride represented by Formula (3),

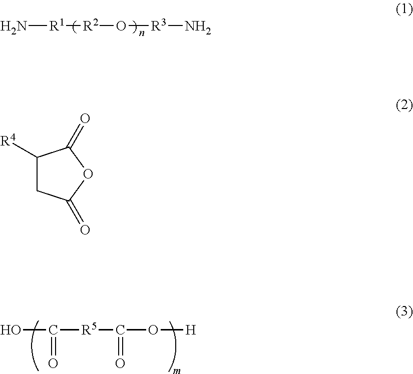

wherein in Formulae (1) to (3), R¹ denotes a single bond or a divalent hydrocarbon group having 1 to 20 carbons, the R²s independently denote a divalent hydrocarbon group having 2 to 20 carbons, R³ denotes a divalent hydrocarbon group having 2 to 20 carbons, n denotes an integer of 1 or greater, the diamine represented by Formula (1) having an amine value of no greater than 0.01 eq/g due to the structures of R¹ to R³ and the number denoted by n, R⁴ denotes a hydrocarbon group having 8 to 30 carbons, R⁵ denotes a divalent hydrocarbon group having 9 to 30 carbons, and m is an integer of 2 or greater,
<10> the resin composition for laser engraving according to any one of <1> to <9> above, wherein Component C has an average particle size of no greater than 100 nm,
<11> the resin composition for laser engraving according to any one of <1> to <10> above, wherein Component C has an average particle size of 3 to 60 nm,
<12> the resin composition for laser engraving according to any one of <1> to <11> above, wherein it further comprises (Component D) a photothermal conversion agent,
<13> the resin composition for laser engraving according to any one of <1> to <12> above, wherein Component A is a plastomer at 25° C.,
<14> the resin composition for laser engraving according to any one of <1> to <13> above, wherein the content of Component B is higher than the content of Component A,
<15> a flexographic printing plate precursor comprising a relief-forming layer comprising the resin composition for laser engraving according to any one of <1> to <14> above,
<16> a flexographic printing plate precursor comprising a crosslinked relief-forming layer formed by crosslinking by means of heat a relief-forming layer comprising the resin composition for laser engraving according to any one of <1> to <14> above,
<17> a process for producing a flexographic printing plate precursor, comprising a layer formation step of forming a relief-forming layer comprising the resin composition for laser engraving according to any one of <1> to <14> above, and a crosslinking step of crosslinking the relief-forming layer by means of heat to thus obtain a flexographic printing plate precursor comprising a crosslinked relief-forming layer,
<18> a process for making a flexographic printing plate, comprising an engraving step of laser-engraving the crosslinked relief-forming layer of the flexographic printing plate precursor according to <16> above to thus form a relief layer, and
<19> a flexographic printing plate comprising a relief layer made by the process for making a flexographic printing plate according to <18> above.

### MODE FOR CARRYING OUT THE PRESENT INVENTION

The present invention is explained in detail below. In the present invention, the notation ‘lower limit to upper limit’, which expresses a numerical range, means ‘at least the lower limit but no greater than the upper limit’, and the notation ‘upper limit to lower limit’ means ‘no greater than the upper limit but at least the lower limit’. That is, they are numerical ranges that include the upper limit and the lower limit. In the present invention, ‘mass %’ is used for the same meaning as ‘weight %’, and ‘parts by mass’ is used for the same meaning as ‘parts by weight’. Furthermore, ‘(Component A) an epoxy resin’ etc. are simply called ‘Component A’ etc.

### (Resin Composition for Laser Engraving)

The resin composition for laser engraving (hereinafter, also called simply a ‘resin composition’) of the present invention comprises (Component A) an epoxy resin, (Component B) an epoxy resin curing agent, and (Component C) a silica, Component B comprising an amine curing agent having an amine value of no greater than 0.01 eq/g or an acid anhydride curing agent having an acid anhydride value of no greater than 0.0050 eq/g.

The resin composition for laser engraving of the present invention may be applied to a wide range of uses where it is subjected to laser engraving, other than use as a relief-forming layer of a flexographic printing plate precursor, without particular limitations. For example, it may be applied not only to a relief-forming layer of a printing plate precursor where formation of a raised relief is carried out by laser engraving, which is explained in detail below, but also to the formation of various types of printing plates or various types of moldings in which image formation is carried out by laser engraving, such as another material form having asperities or openings formed on the surface such as for example an intaglio printing plate, a stencil printing plate, or a stamp.

Among them, the application thereof to the formation of a relief-forming layer provided on an appropriate support is a preferred embodiment.

In the present specification, with respect to explanation of the flexographic printing plate precursor, a non-crosslinked crosslinkable layer comprising Component A to Component C and having a flat surface as an image formation layer that is subjected to laser engraving is called a relief-forming layer, a layer that is formed by crosslinking the relief-forming layer is called a crosslinked relief-forming layer, and a layer that is formed by subjecting this to laser engraving so as to form asperities on the surface is called a relief layer.

Constituent components of the resin composition for laser engraving are explained below.

### (Component A) Epoxy Resin

The resin composition for laser engraving of the present invention comprises (Component A) an epoxy resin.

The epoxy resin in the present invention is a compound having at least two epoxy groups per molecule. The resin composition of the present invention is a composition that can be thermally cured due to Component A and (Component B) an epoxy resin curing agent undergoing a reaction by heating.

Component A may be in a solid form, a syrup form, an oil form, a liquid form, etc. at 25° C., but is particularly preferably an epoxy resin in a syrup, oil, or liquid form. In such a mode, the components in the resin composition have excellent mixing and dispersing properties, a uniform layer can be formed, a flexible relief layer having excellent ink transfer properties is obtained, and the image quality is also excellent.

Component A is preferably a plastomer at 25° C.

The ‘plastomer’ in the present invention means a polymer having the property of easily undergoing deformation by flowing and being able to be solidified in the deformed shape by cooling, as described in ‘New Polymer Dictionary’ Ed. by the Society of Polymer Science, Japan (Published in 1988, Asakura Publishing Co., Ltd., Japan). The term plastomer is the opposite of an elastomer (having the property, when an external force is applied, of deforming in response to the external force and, when the external force is removed, recovering to the original shape in a short time).

In the present invention, the plastomer means that, when the original dimensions are 100%, it can be deformed up to 200% by means of a small external force at room temperature (20° C.) and will not return to 130% or below even if the external force is removed. More particularly, the plastomer means a polymer with which, based on the tensile permanent strain test of JIS K 6262-1997, an I-shaped specimen can be extended to 2 times the gauge length before pulling in a tensile test at 20° C., and the tensile permanent strain measured after extending the specimen to 2 times the gauge length before pulling, subsequently maintaining the specimen for 5 minutes, removing the external tensile force, and maintaining the specimen for 5 minutes, is 30% or greater.

Meanwhile, in the case of a polymer that cannot be subjected to the measurement described above, a polymer which is deformed even if an external force is not applied and does not return to the original shape, corresponds to a plastomer, and for example, a syrup-like resin, an oil-like resin, and a liquid resin correspond thereto.

Furthermore, the plastomer of the present application has a polymer glass transition temperature (Tg) of less than 20° C. In the case of a polymer having two or more Tgs, all of the Tgs are less than 20° C.

The viscosity at 20° C. of Component A is preferably 0.5 Pa·s to 10 kPa·s, more preferably 10 Pa·s to 10 kPa·s, and yet more preferably 50 Pa·s to 5 kPa·s. When the viscosity is in this range, it is easy to mold the resin composition into a sheet-shaped or cylindrical printing plate precursor, and the process is also easy. In the present invention, due to Component A being a plastomer, when molding a printing plate precursor for laser engraving obtained therefrom into a sheet shape or a cylindrical shape, good thickness precision and dimensional precision can be achieved.

The molecular weight or the number-average molecular weight Mn of Component A is preferably 300 to 200,000, more preferably 500 to 150,000, yet more preferably 1,000 to 100,000. A resin composition produced using Component A having a number-average molecular weight in this range is easy to process; moreover, a precursor that is produced by subsequent crosslinking maintains its strength, and a relief image produced from this precursor is strong and can withstand repeated use. A number-average molecular weight and a weight-average molecular weight in the present invention may be measured using, for example, a GPC (gel permeation chromatography) method and determined using a standard polystyrene calibration curve.

Examples of the epoxy polymer that can be used in the present invention include, for examples, crystalline epoxy resins such as a biphenyl type epoxy resin, a bisphenol F type epoxy resin, a bisphenol A type epoxy resin, a stilbene type epoxy resin, and a phenol novolac type epoxy resin; novolac type epoxy resins such as a phenol novolac type epoxy resin, a cresol novolac type epoxy resin, a naphthol novolac type epoxy resin; polyfunctional epoxy resins such as a triphenylmethane type epoxy resin, an alkyl modified triphenylmethane type epoxy resin; aralkyl type epoxy resins such as a phenol aralkyl type epoxy resin having a phenylene skeleton, a phenol aralkyl type epoxy resin having a biphenylene skeleton, a naphthol aralkyl type epoxy resin having a phenylene skeleton, a naphthol aralkyl type epoxy resin having a biphenylene skeleton, a naphthol aralkyl type epoxy resin; naphthol type epoxy resins such as a dihydroxynaphthalene type epoxy resin, an epoxy resin obtained by glycidyl etherification of the dimer of hydroxynaphthalene and/or dihydroxynaphthalene; epoxy resins containing a triazine nucleus such as triglycidyl isocyanurate, a monoallyl diglycidyl isocyanurate; bridge cyclic hydrocarbon compound modified phenol type epoxy resins such as a dicyclopentadiene modified phenol type epoxy resin; and sulfur atom containing type epoxy resins such as a bisphenol S type epoxy resin.

Among them, a bisphenol F type epoxy resin and/or a bisphenol A type epoxy resin are preferable. Using these epoxy resin, compared with the other epoxy resin, processing is easy, a flexible relief layer having excellent ink transfer properties is obtained, and the image quality is also excellent.

As the epoxy resin, commercially available products and those synthesized by any method may be used. Specific examples of commercially available products include EPICLON 1050, 1055, 3050, 4050, 7050, AM-020-P, AM-040-P, HM-091, HM-101, 1050-70X, 1050-75X, 1055-75X, 1051-75M, 7070-40K, HM-091-40AX, 152, 153, 153-60T, 153-60M, 1121N-80M, 1123P-75M, TSR-601, 1650-75MPX, 5500, 5800, 5300-70, 5500-60, EXA-4850-150, EXA-4850-1000, EXA-4816, and EXA-4822 (all manufactured by DIC Corporation), jER 827, 828, 828EL, 828XA, 834, 871, 872, 872X75, 191P, YX310, YX8000, YX8034, YL980, and YL983U (all manufactured by Mitsubishi Chemical Corporation), YD-171, YD-172, YD-172X75, YD-118T, YD-127, YD-128, YD-128G, YD-128S, YD-128CA, YDF-170, YDF-2001, YDF-2004, and YDF-2005RL (all manufactured by Nippon Steel & Sumikin Chemical Co., Ltd.), and the ADEKA RESIN EP-4100 series, EP-4500 series, EP-4900 series, EP-5100 series, EP-4000 series, EP-49 series, and EPU series (all manufactured by ADEKA Corporation).

Among them, preferred examples include EPICLON 840, 850, 850-LC, 830, 835, EXA-4850-150, EXA-4850-1000, EXA-4816, EXA-4822, HP-820, jER 827, 828, 871, 191P, YX310, YX8034, YD-118T, YD-128, YD-128G, YD-1285, YD-128CA, and YDF-170.

With regard to Component A in the resin composition of the present invention, only one type thereof may be used or two or more types thereof may be used in combination.

The content of Component A in the resin composition is preferably 5 to 90 mass % relative to the total solids content, more preferably 15 to 85 mass %, yet more preferably 30 to 80 mass %, and particularly preferably 30 to 60 mass %. It is preferable for the content of Component A to be in the above-mentioned range since the rinsing properties for engraving residue are excellent and a flexible relief layer can be obtained. Meanwhile, the solids content of the resin composition means the content except for the solvent in the resin composition.

The resin composition for laser engraving of the present invention may comprise a binder polymer (resin component) other than Component A. The examples of the binder polymer other than Component A include the non-elastomers described in JP-A-2011-136455, and the unsaturated group-containing polymers described in JP-A-2010-208326.

The resin composition for laser engraving of the present invention preferably comprises Component A as a main component of the binder polymers, and if the resin composition comprises other binder polymers, the content of Component A relative to the total weight of the binder polymers is preferably 60 mass % or greater, more preferably 70 mass % or greater, and yet more preferably 80 mass % or greater. Meanwhile, the upper limit of the content of Component A is not particularly limited, but if the resin composition comprises other binder polymers, the upper limit thereof is preferably 99 mass % or less, more preferably 97 mass % or less, and yet more preferably 95 mass % or less.

### (Component B) Epoxy Resin Curing Agent

The resin composition for laser engraving of the present invention comprises (Component B) an epoxy resin curing agent, Component B comprising an amine curing agent having an amine value of no greater than 0.01 eq/g or an acid anhydride curing agent having an acid anhydride value of no greater than 0.0050 eq/g.

The amine curing agent has an amine value of no greater than 0.01 eq/g, preferably 0.0001 to 0.01 eq/g, more preferably 0.0002 to 0.008 eq/g, yet more preferably 0.0005 to 0.008 eq/g, and particularly preferably 0.0005 to 0.005 eq/g. When in this range, the Tg of the relief layer can be sufficiently decreased, and a flexible relief layer having excellent ink transfer properties is obtained.

The acid anhydride curing agent has an acid anhydride value of no greater than 0.0050 eq/g, preferably 0.0001 to 0.0050 eq/g, more preferably 0.0005 to 0.0050 eq/g, yet more preferably 0.0010 to 0.0050 eq/g, and particularly preferably 0.0025 to 0.0050 eq/g. When in this range, a flexible relief layer having excellent ink transfer properties is obtained.

Methods for measuring and calculating amine value and acid anhydride value in the present invention are not particularly limited, and known methods may be used. Specific preferred examples include the methods below.

When the chemical structure and, furthermore, if necessary the number-average molecular weight, etc. of an amine curing agent or an acid anhydride curing agent are known, a value obtained by dividing the molecular weight (or number-average molecular weight) of the compound by the number of amino groups or anhydride groups per molecule is the amine value or acid anhydride value of this compound.

When the chemical structure, the number-average molecular weight, etc. of an amine curing agent or an acid anhydride curing agent is unknown, a known measurement method for amine value or acid anhydride value may be used for measurement; for example, as a measurement method for amine value, a method in accordance with JIS-K7237 can be cited, and as a measurement method for acid anhydride value, a method in which it is determined by dividing a neutralization number measured in accordance with JIS-K2501 by 2 can preferably be cited.

The resin composition of the present invention may comprise only one type of amine curing agent having an amine value of no greater than 0.01 eq/g or two or more types thereof. Furthermore, the resin composition of the present invention may comprise an amine curing agent having an amine value of greater than 0.01 eq/g, but the content thereof is preferably less than the content of the amine curing agent having an amine value of no greater than 0.01 eq/g; it is more preferably no greater than 1/10 of the content of the amine curing agent having an amine value of no greater than 0.01 eq/g, and particularly preferably none, that is, an amine curing agent having an amine value of greater than 0.01 eq/g is not contained.

In the resin composition of the present invention, an amine curing agent having an amine value of no greater than 0.01 eq/g and an acid anhydride curing agent having an acid anhydride value of no greater than 0.0050 eq/g may be used in combination, but since the amine curing agent and the acid anhydride curing agent often react with each other just by mixing, it is preferable not to use them in combination.

Furthermore, Component B is preferably an amine curing agent.

The amino group of the amine curing agent is preferably a primary amino group and/or a secondary amino group, and more preferably a primary amino group. When in this mode, the curability is excellent, and a flexographic printing plate that is obtained has excellent ink transfer properties.

Furthermore, the number of amino groups of the amine curing agent is preferably 2 to 6, more preferably 2 to 4, and particularly preferably 2, that is, it is a diamine compound. When in this mode, a flexible relief layer having excellent ink transfer properties is obtained.

Furthermore, the amine curing agent preferably has a polyalkyleneoxy chain, and more preferably a polypropyleneoxy chain and/or a polyethyleneoxy chain. When in this range, the Tg of the relief layer can be decreased, and a flexible relief layer having excellent ink transfer properties is obtained.

The molecular weight or number-average molecular weight Mn of the amine curing agent is preferably 300 to 20,000, more preferably 400 to 10,000, yet more preferably 900 to 10,000, and particularly preferably 1,500 to 5,000. When in this range, the Tg of the relief layer can be decreased, and a flexible relief layer having excellent ink transfer properties is obtained.

The amine curing agent is preferably a diamine represented by Formula (1) below. When in this mode, a flexible relief layer having excellent ink transfer properties is obtained.

H₂N—R¹R²—OₙR³—NH₂ (1)

(In Formula (1), R¹ denotes a single bond or a divalent hydrocarbon group having 1 to 20 carbons, the R²s independently denote a divalent hydrocarbon group having 2 to 20 carbons, R³ denotes a divalent hydrocarbon group having 2 to 20 carbons, and n denotes an integer of 1 or greater, the diamine represented by Formula (1) having an amine value of no greater than 0.01 eq/g due to the structures of R¹ to R³ and the number denoted by n.)

The divalent hydrocarbon group having 1 to 20 carbons denoted by R¹ of Formula (1) may be straight chain or branched. The number of carbons of the divalent hydrocarbon group is preferably 1 to 8, and more preferably 1 to 4.

Furthermore, R¹ of Formula (1) is preferably a single bond or a divalent aliphatic hydrocarbon group having 1 to 20 carbons, and more preferably a single bond or an alkylene group having 1 to 20 carbons.

The divalent hydrocarbon groups having 2 to 20 carbons denoted by R² and R³ of Formula (1) may independently be straight chain or branched. The numbers of carbons of the divalent hydrocarbon groups are independently preferably 2 to 8, more preferably 2 to 4, and particularly preferably 2 or 3.

Furthermore, R² and R³ of Formula (1) are independently preferably divalent aliphatic hydrocarbon groups having 2 to 20 carbons, more preferably alkylene groups having 2 to 20 carbons, and particularly preferably ethylene groups and/or propylene groups.

Furthermore, n of Formula (1) is an integer of 1 or greater, preferably an integer of 1 to 500, more preferably an integer of 3 to 500, and yet more preferably an integer of 5 to 100.

The resin composition of the present invention may comprise only one type of acid anhydride curing agent having an acid anhydride value of no greater than 0.0050 eq/g or two or more types thereof. Furthermore, the resin composition of the present invention may comprise an acid anhydride curing agent having an acid anhydride value of greater than 0.0050 eq/g, but the content thereof is preferably less than the content of the acid anhydride curing agent having an acid anhydride value of no greater than 0.0050 eq/g; it is more preferably no greater than 1/10 the content of the acid anhydride curing agent having an acid anhydride value of no greater than 0.0050 eq/g, and particularly preferably none, that is, an acid anhydride curing agent having an acid anhydride value of greater than 0.0050 eq/g is not contained.

The acid anhydride curing agent is preferably an alkylsuccinic anhydride, an alkenylsuccinic anhydride or an aliphatic dibasic acid polyanhydride, and more preferably an alkenylsuccinic anhydride or an aliphatic dibasic acid polyanhydride. When in this mode, a flexible relief layer having excellent ink transfer properties is obtained.

The alkenyl group in the alkenylsuccinic anhydride may be straight chain or branched. The number of carbons of the alkenyl group is preferably 8 to 30, more preferably 8 to 20, and yet more preferably 9 to 18.

The alkyl group in the alkylsuccinic anhydride may be straight chain or branched. The number of carbons of the alkyl group is preferably 8 to 30, more preferably 8 to 20, and yet more preferably 9 to 18.

The acid anhydride curing agent is preferably an anhydride represented by Formula (2) below. When in this mode, a flexible relief layer having excellent ink transfer properties is obtained.

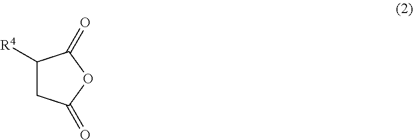

(In Formula (2), R⁴ denotes a hydrocarbon group having 8 to 30 carbons.)

The hydrocarbon group having 8 to 30 carbons denoted by R⁴ of Formula (2) may be straight chain or branched and may have an ethylenically unsaturated bond. The number of carbons of the hydrocarbon group is preferably 8 to 20, and more preferably 9 to 18.

Furthermore, R⁴ of Formula (2) is preferably an aliphatic hydrocarbon group having 8 to 30 carbons, more preferably an aliphatic hydrocarbon group having 8 to 30 carbons and having an ethylenically unsaturated bond, and yet more preferably an alkenyl group having 8 to 30 carbons.

Moreover, the acid anhydride curing agent is preferably an anhydride represented by Formula (3) below. When in this mode, a flexible relief layer having excellent ink transfer properties is obtained.

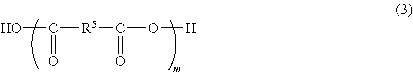

(In Formula (3), R⁵ denotes a divalent hydrocarbon group having 9 to 30 carbons, and m denotes an integer of 2 or greater.)

The divalent hydrocarbon group having 9 to 30 carbons denoted by R⁵ of Formula (3) may be straight chain or branched, and may have an ethylenically unsaturated bond. The number of carbons of the divalent hydrocarbon group is preferably 9 to 28, more preferably 10 to 26, and yet more preferably 12 to 24.

Furthermore, R⁵ of Formula (3) is preferably a divalent aliphatic hydrocarbon group having 9 to 30 carbons, and more preferably an alkylene group having 9 to 30 carbons or an alkenylene group having 9 to 30 carbons.

Moreover, m of Formula (3) is an integer of 2 or greater, preferably an integer of 2 to 500, more preferably an integer of 3 to 500, and yet more preferably an integer of 5 to 100.

Furthermore, examples of the amine curing agent include JEFFAMINE D-400, D-2000, D-4000, ED-600, ED-900, and ED-2003 (all manufactured by Huntsman).

Examples of the alkenylsuccinic anhydride include 2-octenylsuccinic anhydride, nonenylsuccinic anhydride, decenylsuccinic anhydride, 2-dodecen-1-ylsuccinic anhydride, isododecenylsuccinic anhydride, tetradecenylsuccinic anhydride, hexadecenylsuccinic anhydride, octadecenylsuccinic anhydride, isooctadecenylsuccinic anhydride, docosenylsuccinic anhydride, DSA (Sanyo Chemical Industries, Ltd.), PDSA-DA (Sanyo Chemical Industries, Ltd.), RIKACID DDSA (New Japan Chemical Co., Ltd.), and RIKACID OSA (New Japan Chemical Co., Ltd.).

Examples of the alkylsuccinic anhydride include n-octylsuccinic anhydride, decylsuccinic anhydride, dodecylsuccinic anhydride, tetradecylsuccinic anhydride, hexadecylsuccinic anhydride, octadecylsuccinic anhydride, isooctadecylsuccinic anhydride.

Specific examples of the aliphatic dibasic acid polyanhydride include SL-20AH and IPU-22AH (both manufactured by Okamura Oil Mill Co., Ltd.). It is also obtained by a method described in Japanese Examined Patent Application Publication No. 3-57931.

The content of Component B in the resin composition is preferably 5 to 90 mass % relative to the total solids content, more preferably 15 to 80 mass %, yet more preferably 25 to 70 mass %, and particularly preferably 30 to 60 mass %. When the content of Component B is in this range, a flexible relief layer having excellent ink transfer properties is obtained.

Furthermore, in the resin composition of the present invention, it is preferable that the content of Component B is higher than the content of Component A.

### (Component C) Silica

The resin composition for laser engraving of the present invention comprises (Component C) a silica. Due to Component C being contained, a flexographic printing plate having excellent engraving residue rinsing properties and ink transfer properties, in particular engraving residue rinsing properties, is obtained.

Component C is preferably silica particles. The shape of the silica particles may be any shape such as spherical, flat, acicular, amorphous, or one with projections on the surface, but the silica particles are preferably spherical.

The average particle size of Component C is preferably no greater than 100 nm, more preferably 3 to 100 nm, yet more preferably 3 to 60 nm, particularly preferably 3 to 30 nm, and most preferably 3 to 20 nm. When in this range, tackiness at the time of laser engraving can be reduced, engraving residue rinsing properties are excellent, the surface roughness of the printing plate precursor is not greatly affected, and pattern formation is possible by laser engraving without forming a defect in a printed image.

In the present invention, average particle size denotes number-average primary particle size unless otherwise specified.

A measurement method for average particle size is not particularly limited, and examples include a method in which an average value is calculated for values of the major diameter measured by microscope observation. Specifically, a method in which the magnification is adjusted so that at least approximately 50 particles are present within the field of view of a microscope, the major diameter of each particle is measured, the average value is calculated, and this is defined as the average particle size can preferably be cited. In the measurement, it is preferable to use a microscope that has a length measuring function, but dimensions may be measured from a photograph taken using a camera.

As the silica, porous particles and nonporous particles can be cited.

The porous particles referred to here are defined as particles having fine pores having a pore volume of at least 0.1 mL/g in the particle or particles having fine cavities.

The porous particles preferably have a specific surface area of at least 10 m²/g but no greater than 1,500 m²/g, an average pore diameter of at least 1 nm but no greater than 1,000 nm, a pore volume of at least 0.1 mL/g but no greater than 10 mL/g, and an oil adsorption of at least 10 mL/100 g but no greater than 2,000 mL/100 g. The specific surface area is determined based on the BET equation from the adsorption isotherm of nitrogen at −196° C. Furthermore, measurement of the pore volume and the average pore diameter preferably employs a nitrogen adsorption method. Measurement of the oil adsorption may be suitably carried out in accordance with JIS-K5101.

The number-average primary particle size of the porous particles is preferably at least 0.01 μm but no greater than 10 μm, more preferably at least 0.5 μm but no greater than 8 μm, and yet more preferably at least 1 μm but no greater than 5 μm.

The shape of the porous particles is not particularly limited, and spherical, flat-shaped, needle-shaped, or amorphous particles, or particles having projections on the surface, etc. may be used.

Furthermore, particles having a cavity in the interior, spherical granules having a uniform pore diameter such as a silica sponge, etc. may be used. Examples thereof are not particularly limited but include porous silica, mesoporous silica, a silica-zirconia porous gel, porous alumina, and a porous glass. Furthermore, as for a layered clay compound, pore diameter cannot be defined for those having a cavity of a few nm to a few hundred nm between layers, and in the present embodiment the distance between cavities present between layers is defined as the pore diameter.

Moreover, particles obtained by subjecting the surface of porous particles to a surface modifying treatment by covering with a silane coupling agent, a titanium coupling agent, or another organic compound so as to make the surface hydrophilic or hydrophobic may also be used. With regard to these porous particles, one type or two or more types may be selected.

The nonporous particles are defined as particles having a pore volume of less than 0.1 mL/g. The number-average particle size of the nonporous particles is the number-average particle size for primary particles as the target, and is preferably at least 10 nm but no greater than 500 nm, and more preferably at least 10 nm but no greater than 100 nm.

The silica that can be used in the present invention is preferably silica particles, and preferred examples include the commercially available products listed below. The figures inside parentheses denote average particle size.

Examples of those manufactured by Nippon Aerosil Co., Ltd. include AEROSIL RM50 (40 nm), R711 (12 nm), R7200 (12 nm), OX50 (40 nm), 50 (30 nm), 90G (20 nm), R202 (17 nm), 130 (16 nm), 150 (14 nm), 200 (12 nm), 200CF (12 nm), 300 (7 nm), and 380 (7 nm).

Examples of those manufactured by AGC Si-Tech Co., Ltd. include Sunsphere H-31 (3 μm), H-51 (5 μm), H-121 (12 μm), H-201 (20 μm), L-31 (3 μm), L-51 (5 μm), NP-30 (4 μm), NP-100 (10 μm), and NP-200 (20 μm).

Examples of those manufactured by Nissan Chemical Industries Ltd. include methanol silica sol (10 to 20 nm), MA-ST-M (10 to 20 nm), IPA-ST (10 to 20 nm), EG-ST (10 to 20 nm), EG-ST-ZL (70 to 100 nm), NPC-ST (10 to 20 nm), DMAC-ST (10 to 20 nm), MEK-ST (10 to 20 nm), XBA-ST (10 to 20 nm), and MIBK-ST (10 to 20 nm).

The content of Component C in the resin composition for laser engraving of the present invention is not particularly limited, but it is preferably in the range of 1 to 30 mass % relative to the total solids content, more preferably in the range of 3 to 20 mass %, and most preferably in the range of 5 to 15 mass %. When the content of Component C is in this range, the surface roughness of the printing plate precursor is not greatly affected, and tackiness can be reduced without forming a defect in a printed image. Furthermore, engraving residue rinsing properties and ink transfer properties are excellent.

### (Component D) Photothermal Conversion Agent

The resin composition for laser engraving of the present invention preferably further includes a photothermal conversion agent. That is, it is considered that the photothermal conversion agent in the present invention can promote the thermal decomposition of a cured material during laser engraving by absorbing laser light and generating heat. Therefore, it is preferable that a photothermal conversion agent capable of absorbing light having a wavelength of laser used for graving be selected.

When a laser (a YAG laser, a semiconductor laser, a fiber laser, a surface emitting laser, etc.) emitting infrared at a wavelength of 700 to 1,300 nm is used as a light source for laser engraving, it is preferable for the flexographic printing plate precursor for laser engraving which is produced by using the resin composition for laser engraving of the present invention to comprise a photothermal conversion agent that has a maximun absorption wavelength at 700 to 1,300 nm.

As the photothermal conversion agent in the present invention, various types of dye or pigment are used.

With regard to the photothermal conversion agent, examples of dyes that can be used include commercial dyes and known dyes described in publications such as ‘Senryo Binran’ (Dye Handbook) (Ed. by The Society of Synthetic Organic Chemistry, Japan, 1970). Specific examples include dyes having a maximum absorption wavelength at 700 to 1,300 nm, and preferable examples include azo dyes, metal complex salt azo dyes, pyrazolone azo dyes, naphthoquinone dyes, anthraquinone dyes, phthalocyanine dyes, carbonium dyes, diimmonium compounds, quinone imine dyes, methine dyes, cyanine dyes, squarylium colorants, pyrylium salts, and metal thiolate complexes. In particular, cyanine-based colorants such as heptamethine cyanine colorants, oxonol-based colorants such as pentamethine oxonol colorants, and phthalocyanine-based colorants are preferably used. Examples include dyes described in paragraphs 0124 to 0137 of JP-A-2008-63554.

With regard to the photothermal conversion agent used in the present invention, examples of pigments include commercial pigments and pigments described in the Color Index (C.I.) Handbook, ‘Saishin Ganryo Binran’ (Latest Pigments Handbook) (Ed. by Nippon Ganryo Gijutsu Kyokai, 1977), ‘Saishin Ganryo Ouyogijutsu’ (Latest Applications of Pigment Technology) (CMC Publishing, 1986), ‘Insatsu Inki Gijutsu’ (Printing Ink Technology) (CMC Publishing, 1984). Examples of pigments include pigments described in paragraphs 0122 to 0125 of JP-A-2009-178869.

Among these pigments, carbon black is preferable. Any carbon black, regardless of classification by ASTM (American Society for Testing and Materials) and application (e.g. for coloring, for rubber, for dry cell, etc.), may be used as long as dispersibility, etc. in the resin composition for laser engraving is stable. Examples of the carbon black include furnace black, thermal black, channel black, lamp black, and acetylene black. In order to make dispersion easy, a black colorant such as carbon black may be used as color chips or a color paste by dispersing it in nitrocellulose or a binder in advance using, as necessary, a dispersant, and such chips and paste are readily available as commercial products. Examples of carbon black include carbon blacks described in paragraphs 0130 to 0134 of JP-A-2009-178869.

Component D in the resin composition of the present invention may be used singly or in a combination of two or more compounds.

The content of the photothermal conversion agent in the resin composition for laser engraving of the present invention may vary greatly with the magnitude of the molecular extinction coefficient inherent to the molecule, but the content is preferably 0.01 to 30 mass %, more preferably 0.05 to 20 mass %, and particularly preferably 0.1 to 10 mass %, relative to the total mass of the resin composition.

### (Component E) Solvent

When preparing the resin composition for laser engraving of the present invention, (Component E) a solvent may be used.

When the solvent is used, an organic solvent is preferably used. Specific preferred examples of the aprotic organic solvent include acetonitrile, tetrahydrofuran, dioxane, toluene, propylene glycol monomethyl ether acetate, methyl ethyl ketone, acetone, methyl isobutyl ketone, ethyl acetate, butyl acetate, ethyl lactate, N,N-dimethylacetamide, N-methylpyrrolidone, and dimethyl sulfoxide.

Specific preferred examples of the protic organic solvent include methanol, ethanol, 1-propanol, 2-propanol, 1-butanol, 1-methoxy-2-propanol, ethylene glycol, diethylene glycol, and 1,3-propanediol.

Among these, propylene glycol monomethyl ether acetate is preferable.

The content of the solvent is not particularly limited, and the content necessary for forming a relief-forming layer, etc. may be added. Meanwhile, the solids content of the resin composition means the content except for the solvent in the resin composition.

### <Other Additives>

The resin composition for laser engraving of the present invention may comprise as appropriate various types of known additives as long as the effects of the present invention are not inhibited. Examples include a plasticizer, a filler other than silica, a wax, a fragrance, an ultraviolet absorbent, a glidant, a lubricant, a process oil, an a metal oxide, an antiozonant, an anti-aging agent, a thermopolymerization inhibitor, and a colorant, and one type thereof may be used on its own or two more types may be used in combination.

The resin composition for laser engraving of the present invention may comprise a plasticizer. When Component A comprises an epoxy resin that is in a syrup, oil, or liquid form at 25° C., the relief layer obtained has excellent flexibility, and no plasticizer need be added.

A plasticizer has the function of making a film formed from the resin composition flexible, and it is necessary for it to be compatible with a binder polymer.

Examples of the plasticizer include phthalic acid esters such as dipentyl phthalate, dihexyl phthalate, dicyclohexyl phthalate, diphenyl phthalate, di-n-octyl phthalate, bis(2-ethylhexyl)phthalate, diisodecyl phthalate, ditridecyl phthalate, butyl benzyl phthalate, and bis(2-butoxyethyl)phthalate, trimellitic acid esters such as tris(2-ethylhexyl)trimellitate and tributyl trimellitate, phosphoric acid esters such as trihexyl phosphate, tris(2-ethylhexyl)phosphate, tributoxyethyl phosphate, tricyclohexyl phosphate, triphenyl phosphate, tribenzyl phosphate, tricresyl phosphate, cresyl diphenyl phosphate, tris(1,3-dichloro-2-propyl)phosphate, and tris(2-chloroethyl)phosphate, malonic acid esters such as diethyl malonate, di-n-butyl malonate, and dibenzyl malonate, succinic acid esters such as dibutyl succinate and dioctyl succinate, adipic acid esters such as bis(2-butoxyethyl)adipate, dibutyl adipate, dimethyl adipate, and diisobutyl adipate, sebacic acid esters such as dimethyl sebacate and di-n-butyl sebacate, maleic acid esters such as dibutyl maleate, dihexyl maleate, and dioctyl maleate, fumaric acid esters such as dibutyl fumarate, dihexyl fumarate, and dioctyl fumarate, triester compounds such as triacetin, tributyrin, tributyl citrate, and triethyl citrate, and fatty acid esters such as acetic acid esters and propionic acid esters.

With regard to the plasticizer in the resin composition of the present invention, one type thereof may be used on its own or two or more types may be used in combination.

From the viewpoint of stability over time, the content of the plasticizer in the resin composition for laser engraving of the present invention is preferably no greater than 50 mass % of the entire solids content, more preferably no greater than 30 mass %, yet more preferably no greater than 10 mass %, and particularly preferably none.

### (Flexographic Printing Plate Precursor for Laser Engraving)

A first embodiment of the flexographic printing plate precursor for laser engraving of the present invention comprises a relief-forming layer formed from the resin composition for laser engraving of the present invention.

A second embodiment of the flexographic printing plate precursor for laser engraving of the present invention comprises a crosslinked relief-forming layer formed by crosslinking a relief-forming layer formed from the resin composition for laser engraving of the present invention.

In the present invention, the ‘flexographic printing plate precursor for laser engraving’ means both or one of a flexographic printing plate precursor having a crosslinkable relief-forming layer formed from the resin composition for laser engraving in a state before being crosslinked and a flexographic printing plate precursor in a state in which it is cured by light or heat.

The flexographic printing plate precursor for laser engraving of the present invention is a flexographic printing plate precursor having a crosslinkable relief-forming layer cured by heat.

In the present invention, the ‘relief-forming layer’ means a layer in a state before being crosslinked, that is, a layer formed from the resin composition for laser engraving of the present invention, which may be dried as necessary.

In the present invention, the “crosslinked relief-forming layer” refers to a layer obtained by crosslinking the aforementioned relief-forming layer. The crosslinking is preferably performed by heat. Moreover, the crosslinking is not particularly limited only if it is a reaction that cures the resin composition, and is a general idea that includes the crosslinked structure by the reaction of Component A and Component B and the crosslinked structure by the reaction of Component A with each other, and the reaction of Component A with other Component. When a polymerizable compound is used, the crosslinking includes a crosslinking by polymerization of polymerizable compounds.

The ‘flexographic printing plate’ is made by laser engraving the flexographic printing plate precursor having the crosslinked relief-forming layer.

Moreover, in the present invention, the ‘relief layer’ means a layer of the flexographic printing plate formed by engraving using a laser, that is, the crosslinked relief-forming layer after laser engraving.

A flexographic printing plate precursor for laser engraving of the present invention comprises a relief-forming layer formed from the resin composition for laser engraving of the present invention, which has the above-mentioned components. The (crosslinked) relief-forming layer is preferably provided above a support.

The (crosslinked) flexographic printing plate precursor for laser engraving may further comprise, as necessary, an adhesive layer between the support and the (crosslinked) relief-forming layer and, above the relief-forming layer, a slip coat layer and a protection film.

### <Relief-Forming Layer>

The relief-forming layer is a layer formed from the resin composition for laser engraving of the present invention, and is preferably crosslinkable by heat.

As a mode in which a flexographic printing plate is prepared using the flexographic printing plate precursor for laser engraving, a mode in which a flexographic printing plate is prepared by crosslinking a relief-forming layer to thus form a flexographic printing plate precursor having a crosslinked relief-forming layer, and the crosslinked relief-forming layer (hard relief-forming layer) is then laser-engraved to thus form a relief layer is preferable. By crosslinking the relief-forming layer, it is possible to prevent abrasion of the relief layer during printing, and it is possible to obtain a flexographic printing plate having a relief layer with a sharp shape after laser engraving.

The relief-forming layer may be formed by molding the resin composition for laser engraving that has the above-mentioned components for a relief-forming layer into a sheet shape or a sleeve shape. The relief-forming layer is usually provided above a support, which is described later, but it may be formed directly on the surface of a member such as a cylinder of equipment for plate producing or printing or may be placed and immobilized thereon, and a support is not always required.

A case in which the relief-forming layer is mainly formed in a sheet shape is explained as an example below.

### <Support>

A material used for the support of the flexographic printing plate precursor for laser engraving is not particularly limited, but one having high dimensional stability is preferably used, and examples thereof include metals such as steel, stainless steel, or aluminum, plastic resins such as a polyester (e.g. polyethylene terephthalate (PET), polybutylene terephthalate (PBT), or polyacrylonitrile (PAN)) or polyvinyl chloride, synthetic rubbers such as styrene-butadiene rubber, and glass fiber-reinforced plastic resins (epoxy resin, phenolic resin, etc.). As the support, a PET film or a steel substrate is preferably used. The configuration of the support depends on whether the relief-forming layer is in a sheet shape or a sleeve shape.

### <Adhesive Layer>

An adhesive layer may be provided between the relief-forming layer and the support for the purpose of strengthening the adhesion between the two layers. Examples of materials (adhesives) that can be used in the adhesive layer include those described in ‘Handbook of Adhesives’, Second Edition, Ed by I. Skeist, (1977).

### <Protection Film, Slip Coat Layer>

For the purpose of preventing scratches or dents in the relief-forming layer surface or the crosslinked relief-forming layer surface, a protection film may be provided on the relief-forming layer surface or the crosslinked relief-forming layer surface. The thickness of the protection film is preferably 25 to 500 μm, and more preferably 50 to 200 μm. The protection film may employ, for example, a polyester-based film such as PET or a polyolefin-based film such as PE (polyethylene) or PP (polypropylene). The surface of the film may be made matte. The protection film is preferably peelable.

When the protection film is not peelable or conversely has poor adhesion to the relief-forming layer, a slip coat layer may be provided between the two layers. The material used in the slip coat layer preferably employs as a main component a resin that is soluble or dispersible in water and has little tackiness, such as polyvinyl alcohol, polyvinyl acetate, partially saponified polyvinyl alcohol, a hydroxyalkylcellulose, an alkylcellulose, or a polyamide resin.

### <Process for Producing Flexographic Printing Plate Precursor for Laser Engraving>

The process for producing a flexographic printing plate precursor for laser engraving is not particularly limited, and examples thereof include a method in which a resin composition for laser engraving is prepared, solvent is removed from this coating solution composition for laser engraving, and it is then melt-extruded onto a support. Alternatively, a method may be employed in which a resin composition for laser engraving is cast onto a support, and this is dried in an oven to thus remove solvent from the resin composition.

Among them, the process for producing a flexographic printing plate precursor for laser engraving of the present invention is preferably a production process comprising a layer formation step of forming a relief-forming layer from the resin composition for laser engraving of the present invention and a crosslinking step of crosslinking the relief-forming layer by means of heat to thus obtain a flexographic printing plate precursor having a crosslinked relief-forming layer.

Subsequently, as necessary, a protection film may be laminated on the relief-forming layer. Laminating may be carried out by compression-bonding the protection film and the relief-forming layer by means of heated calendar rollers, etc. or putting a protection film into intimate contact with a relief-forming layer whose surface is impregnated with a small amount of solvent.

When a protection film is used, a method in which a relief-forming layer is first layered on a protection film and a support is then laminated may be employed.

When an adhesive layer is provided, it may be dealt with by use of a support coated with an adhesive layer. When a slip coat layer is provided, it may be dealt with by use of a protection film coated with a slip coat layer.

### <Layer Formation Step>

The process for producing the flexographic printing plate precursor for laser engraving of the present invention preferably comprises a layer formation step of forming a relief-forming layer from the resin composition for laser engraving of the present invention.

Preferred examples of a method for forming the relief-forming layer include a method in which the resin composition for laser engraving of the present invention is prepared, solvent is removed as necessary from this resin composition for laser engraving, and it is then melt-extruded onto a support and a method in which the resin composition for laser engraving of the present invention is prepared, the resin composition for laser engraving of the present invention is cast onto a support, and this is dried in an oven to thus remove solvent.

The resin composition for laser engraving may be produced by, for example, dissolving or dispersing Components A and B, and optional components in an appropriate solvent, and then dispersing Component C.

The thickness of the (crosslinked) relief-forming layer in the flexographic printing plate precursor for laser engraving is preferably 0.05 to 10 mm before and after crosslinking, more preferably 0.05 to 7 mm, and yet more preferably 0.05 to 3 mm.

### <Crosslinking Step>

The process for producing a flexographic printing plate precursor for laser engraving of the present invention is preferably a production process comprising a crosslinking step of crosslinking the relief-forming layer by means of heat to thus obtain a flexographic printing plate precursor having a crosslinked relief-forming layer.

The relief-forming layer may be crosslinked by heating the flexographic printing plate precursor for laser engraving (step of crosslinking by means of heat). As heating means for carrying out crosslinking by heat, there can be cited a method in which a printing plate precursor is heated in a hot air oven or a far-infrared oven for a predetermined period of time and a method in which it is put into contact with a heated roller for a predetermined period of time.

As a method for crosslinking the relief-forming layer, from the viewpoint of the relief-forming layer being uniformly curable (crosslinkable) from the surface into the interior, crosslinking by heat is preferable.

Due to the relief-forming layer being crosslinked, firstly, a relief formed after laser engraving becomes sharp and, secondly, tackiness of engraving residue formed when laser engraving is suppressed. If an uncrosslinked relief-forming layer is laser-engraved, residual heat transmitted to an area around a laser-irradiated part easily causes melting or deformation of a part that is not targeted, and a sharp relief layer cannot be obtained in some cases.

The crosslinking step is a step of carrying out crosslinking by heat, although there is the advantage that particularly expensive equipment is not needed, since a printing plate precursor reaches a high temperature, it is necessary to carefully select the starting materials used while taking into consideration the possibility that a thermoplastic polymer, which becomes soft at high temperature, will deform during heating, etc.

### (Flexographic Printing Plate and Process for Making Same)

The process for making a flexographic printing plate of the present invention preferably comprises a layer formation step of forming a relief-forming layer from the resin composition for laser engraving of the present invention, a crosslinking step of crosslinking the relief-forming layer by means of heat and/or light to thus obtain a flexographic printing plate precursor having a crosslinked relief-forming layer, and an engraving step of laser-engraving the flexographic printing plate precursor having the crosslinked relief-forming layer, and more preferably comprises a layer formation step of forming a relief-forming layer from the resin composition for laser engraving of the present invention, a crosslinking step of crosslinking the relief-forming layer by means of heat to thus obtain a flexographic printing plate precursor having a crosslinked relief-forming layer, and an engraving step of laser-engraving the flexographic printing plate precursor having the crosslinked relief-forming layer.

The flexographic printing plate of the present invention is a flexographic printing plate having a relief layer obtained by crosslinking and laser-engraving a layer formed from the resin composition for laser engraving of the present invention, and is preferably a flexographic printing plate made by the process for producing a flexographic printing plate of the present invention.

The flexographic printing plate of the present invention may suitably employ an aqueous ink when printing.

The layer formation step and the crosslinking step in the process for producing a flexographic printing plate of the present invention mean the same as the layer formation step and the crosslinking step in the above-mentioned process for producing a flexographic printing plate precursor for laser engraving, and preferred ranges are also the same.

### <Engraving Step>

The process for producing a flexographic printing plate of the present invention preferably comprises an engraving step of laser-engraving the flexographic printing plate precursor having a crosslinked relief-forming layer.

The engraving step is a step of laser-engraving a crosslinked relief-forming layer that has been crosslinked in the crosslinking step to thus form a relief layer. Specifically, it is preferable to engrave a crosslinked relief-forming layer that has been crosslinked with laser light according to a desired image, thus forming a relief layer. Furthermore, a step in which a crosslinked relief-forming layer is subjected to scanning irradiation by controlling a laser head using a computer in accordance with digital data of a desired image can preferably be cited.

This engraving step preferably employs an infrared laser. When irradiated with an infrared laser, molecules in the crosslinked relief-forming layer undergo molecular vibration, thus generating heat. When a high power laser such as a carbon dioxide laser or a YAG laser is used as the infrared laser, a large quantity of heat is generated in the laser-irradiated area, and molecules in the crosslinked relief-forming layer undergo molecular scission or ionization, thus being selectively removed, that is, engraved. The advantage of laser engraving is that, since the depth of engraving can be set freely, it is possible to control the structure three-dimensionally. For example, for an area where fine halftone dots are printed, carrying out engraving shallowly or with a shoulder prevents the relief from collapsing due to printing pressure, and for a groove area where a fine outline character is printed, carrying out engraving deeply makes it difficult for ink the groove to be blocked with ink, thus enabling breakup of an outline character to be suppressed.

In particular, when engraving is carried out using an infrared laser that corresponds to the absorption wavelength of the photothermal conversion agent, it becomes possible to selectively remove the crosslinked relief-forming layer at higher sensitivity, thus giving a relief layer having a sharp image.

As the infrared laser used in the engraving step, from the viewpoint of productivity, cost, etc., a carbon dioxide laser (a CO₂ laser) or a semiconductor laser is preferable. In particular, a fiber-coupled semiconductor infrared laser (FC-LD) is preferably used. In general, compared with a CO₂ laser, a semiconductor laser has higher efficiency laser oscillation, is less expensive, and can be made smaller. Furthermore, it is easy to form an array due to the small size. Moreover, the shape of the beam can be controlled by treatment of the fiber.

With regard to the semiconductor laser, one having a wavelength of 700 to 1,300 nm is preferable, one having a wavelength of 800 to 1,200 nm is more preferable, one having a wavelength of 860 to 1,200 nm is yet more preferable, and one having a wavelength of 900 to 1,100 nm is particularly preferable.

Furthermore, the fiber-coupled semiconductor laser can output laser light efficiently by being equipped with optical fiber, and this is effective in the engraving step in the present invention. Moreover, the shape of the beam can be controlled by treatment of the fiber. For example, the beam profile may be a top hat shape, and energy can be applied stably to the plate face. Details of semiconductor lasers are described in ‘Laser Handbook 2^{nd} Edition’ The Laser Society of Japan, Applied Laser Technology, The Institute of Electronics and Communication Engineers, etc.

Moreover, as plate making equipment comprising a fiber-coupled semiconductor laser that can be used suitably in the process for making a flexographic printing plate employing the flexographic printing plate precursor of the present invention, those described in detail in JP-A-2009-172658 and JP-A-2009-214334 can be cited. Such equipment comprising a fiber-coupled semiconductor laser can be used to produce a flexographic printing plate of the present invention.

The process for producing a flexographic printing plate of the present invention may as necessary further comprise, subsequent to the engraving step, a rinsing step, a drying step, and/or a post-crosslinking step, which are shown below.

Rinsing step: a step of rinsing the engraved surface by rinsing the engraved relief layer surface with water or a liquid comprising water as a main component.

Drying step: a step of drying the engraved relief layer.

Post-crosslinking step: a step of further crosslinking the relief layer by applying energy to the engraved relief layer.

After the above-mentioned step, since engraved residue is attached to the engraved surface, a rinsing step of washing off engraved residue by rinsing the engraved surface with water or a liquid comprising water as a main component may be added. Examples of rinsing means include a method in which washing is carried out with tap water, a method in which high pressure water is spray-jetted, and a method in which the engraved surface is brushed in the presence of mainly water using a batch or conveyor brush type washout machine known as a photosensitive resin letterpress plate processor, and when slime due to engraved residue cannot be eliminated, a rinsing liquid to which a soap or a surfactant is added may be used.

When the rinsing step of rinsing the engraved surface is carried out, it is preferable to add a drying step of drying an engraved relief-forming layer so as to evaporate rinsing liquid.

Furthermore, as necessary, a post-crosslinking step for further crosslinking the relief-forming layer may be added. By carrying out a post-crosslinking step, which is an additional crosslinking step, it is possible to further strengthen the relief formed by engraving.

The pH of the rinsing liquid that can be used in the present invention is preferably at least 9, more preferably at least 10, and yet more preferably at least 11. The pH of the rinsing liquid is preferably no greater than 14, more preferably no greater than 13.5, and yet more preferably no greater than 13.1. When in the above-mentioned range, handling is easy.

In order to set the pH of the rinsing liquid in the above-mentioned range, the pH may be adjusted using an acid and/or a base as appropriate, and the acid or base used is not particularly limited.

The rinsing liquid that can be used in the present invention preferably comprises water as a main component.

The rinsing liquid may contain as a solvent other than water a water-miscible solvent such as an alcohol, acetone, or tetrahydrofuran.

The rinsing liquid preferably comprises a surfactant.

From the viewpoint of removability of engraved residue and little influence on a flexographic printing plate, preferred examples of the surfactant that can be used in the present invention include betaine compounds (amphoteric surfactants) such as a carboxybetaine compound, a sulfobetaine compound, a phosphobetaine compound, an amine oxide compound, and a phosphine oxide compound.

Furthermore, examples of the surfactant also include known anionic surfactants, cationic surfactants, and nonionic surfactants. Moreover, a fluorine-based or silicone-based nonionic surfactant may also be used in the same manner.

With regard to the surfactant, one type may be used on its own or two or more types may be used in combination.

It is not necessary to particularly limit the amount of surfactant used, but it is preferably 0.01 to 20 mass % relative to the total mass of the rinsing liquid, and more preferably 0.05 to 10 mass %.

The flexographic printing plate of the present invention having a relief layer above the surface of an optional substrate such as a support may be produced as described above.

From the viewpoint of satisfying suitability for various aspects of printing, such as abrasion resistance and ink transfer properties, the thickness of the relief layer of the flexographic printing plate is preferably at least 0.05 mm but no greater than 10 mm, more preferably at least 0.05 mm but no greater than 7 mm, and yet more preferably at least 0.05 mm but no greater than 3 mm.

Furthermore, the Shore A hardness of the relief layer of the flexographic printing plate is preferably at least 50° but no greater than 90°. When the Shore A hardness of the relief layer is at least 50°, even if fine halftone dots formed by engraving receive a strong printing pressure from a letterpress printer, they do not collapse and close up, and normal printing can be carried out. Furthermore, when the Shore A hardness of the relief layer is no greater than 90°, even for flexographic printing with kiss touch printing pressure it is possible to prevent patchy printing in a solid printed part.

The Shore A hardness in the present specification is a value measured by a durometer (a spring type rubber hardness meter) that presses an indenter (called a pressing needle or indenter) into the surface of a measurement target at 25° C. so as to deform it, measures the amount of deformation (indentation depth), and converts it into a numerical value.

A glass transition temperature (Tg) of the crosslinked relief-forming layer of the flexographic printing plate precursor and a glass transition temperature (Tg) of the relief layer of the flexographic printing plate is preferably less than 25° C., and more preferably less than 10° C., and preferably −150° C. or above. Methods for measuring a glass transition temperature (Tg) are not particularly limited, and specific preferred examples include a method of measuring the temperature dependence of tans at 100 Hz was measured (measurement range: −50° C. to 100° C.) by a dynamic mechanical analysis (DMA) meter, and then the temperature was plotted on the abscissa, and tans on the ordinate, and the temperature at which tans became a maximum is defined as the Tg.

The flexographic printing plate of the present invention is particularly suitable for printing by a flexographic printer using an aqueous ink, but printing is also possible when it is carried out by a letterpress printer using any of aqueous, oil-based, and UV inks, and printing is also possible when it is carried out by a flexographic printer using a UV ink. The flexographic printing plate of the present invention has excellent rinsing properties, there is no engraved residue, the relief layer obtained has excellent elasticity, and the flexographic printing plate has excellent ink transfer properties of several inks and printing durability, and printing can be carried out for a long period of time without plastic deformation of the relief layer or degradation of printing durability.

In accordance with the present invention, there can be provided a resin composition for laser engraving that can give a flexographic printing plate having excellent engraving residue rinsing properties and ink transfer properties, a flexographic printing plate precursor for laser engraving and a process for producing same employing the resin composition for laser engraving, and a flexographic printing plate and a process for making same.

### EXAMPLES

The present invention is explained in further detail below by reference to Examples, but the present invention should not be construed as being limited to these Examples. Furthermore, ‘parts’ in the description below means ‘parts by mass’, and ‘%’ means ‘mass %’, unless otherwise specified.

Moreover, the number-average molecular weight (Mn) of a polymer in the Examples are values measured by a GPC method unless otherwise specified.

### <Measurement of Number-Average Molecular Weight (Mn) of Resin>

The number-average molecular weight of a resin was determined using gel permeation chromatography (GPC) on the basis of a polystyrene of known molecular weight. Measurement was carried out using a high performance GPC system (HLC-8020, Tosoh Corporation) and a polystyrene-packed column (TSKgeI GMHXL, Tosoh Corporation) while developing with tetrahydrofuran (THF). The temperature of the column was set at 40° C. As the sample that was injected into the GPC system, a THF solution having a resin concentration of 1 wt % was prepared, and the amount injected was 10 μL. Furthermore, as a detector, a resin UV absorption detector was used, and as a monitoring light, light at 254 nm was used.

### Example 1

A separable flask was charged with 40 parts of EXA-4816 (DIC Corporation) as an epoxy resin, 51 parts of D-2000 (polypropylene glycol diamine, compound below (x being about 33), Huntsman) as an amine curing agent, 3 parts of AEROSIL R202 (silica, average primary particle size: 14 nm, Nippon Aerosil Co., Ltd.), 5 parts of Ketjen Black EC600JD (carbon black, Lion Corporation) as a photothermal conversion agent, and 27 parts of propylene glycol monomethyl ether acetate (PGMEA), and stirring was carried out at 70° C. and 150 rpm for 2 hours, thus preparing a resin composition for laser engraving.

A spacer (frame) having a predetermined thickness was placed on a PET substrate, the resin composition obtained was cast gently so that it did not flow out of the spacer (frame), and it was heated at 120° C. for 2 hours and further at 100° C. for 3 hours so as to thermally crosslink a relief-forming layer; a relief-forming layer having a thickness of about 1 mm was thus provided, and a flexographic printing plate precursor for laser engraving was thereby prepared.

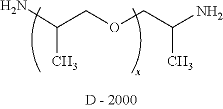

The relief-forming layer after crosslinking (crosslinked relief-forming layer) was engraved using the two types of laser below.

As a carbon dioxide laser engraving machine, for engraving by irradiation with a laser, an ML-9100 series high quality CO₂ laser marker (Keyence) was used. A 1 cm square solid printed area was raster-engraved using the carbon dioxide laser engraving machine under conditions of an output of 12 W, a head speed of 200 mm/sec, and a pitch setting of 2,400 DPI.

As a semiconductor laser engraving machine, laser recording equipment provided with an SDL-6390 fiber-coupled semiconductor laser (FC-LD) (JDSU, wavelength 915 nm) with a maximum power of 8.0 W was used. A 1 cm square solid printed area was raster-engraved using the semiconductor laser engraving machine under conditions of a laser output of 7.5 W, a head speed of 409 mm/sec, and a pitch setting of 2,400 DPI.

The thickness of the relief layer of the flexographic printing plate thus obtained was about 1 mm.

### Examples 2 to 15 and Comparative Examples 1 to 5

Flexographic printing plate precursors for laser engraving and flexographic printing plates of Examples 2 to 15 and Comparative Examples 1 to 5 were prepared in the same method as in Example 1 except that the epoxy resin (Component A), the epoxy resin curing agent (Component B), the silica (Component C), and the photothermal conversion agent (Component D) were changed to those described in Table 1.

With regard to the amount of epoxy resin curing agent (Component B) added in Examples 2 to 15 and Comparative Examples 1 to 5, when Component B was an amine curing agent the amount of Component B added was changed so that epoxy equivalent:amine equivalent=2:1, and when it was an acid anhydride curing agent, epoxy equivalent:anhydride equivalent=1:0.9.

Each of the Examples and Comparative Examples was subjected to evaluation in terms of glass transition temperature (Tg), rinsing properties, and ink transfer properties by the methods described below. The evaluation results are summarized in Table 1.

### <Glass Transition Temperature (Tg)>

A crosslinked relief-forming layer was cut out to give a piece with a width of 5.5 mm, it was set in a Rheogel-E4000 dynamic mechanical analysis (DMA) meter (UBM), and the temperature dependence of tans at 100 Hz was measured (measurement range: −50° C. to 100° C.). The temperature was plotted on the abscissa, and tans on the ordinate, and the temperature at which tans became a maximum was defined as the Tg. The evaluation criteria were as follows: when the Tg was 25° C. or above, it was evaluated as poor, when it was from less than 25° C. to 10° C. it was evaluated as fair, and when it was less than 10° C. it was evaluated as good.

### <Rinsing Properties>

A laser-engraved plate was immersed in water and an engraved part was rubbed with a toothbrush (Clinica Flat Cut Toothbrush, Lion Corporation) 10 times. Subsequently, the presence/absence of engraving residue was visually checked, and when there was no engraving residue, the evaluation was good, when there was a small amount of engraving residue but there was no practical problem the evaluation was fair, and when the engraving residue remained beyond a level that would cause a practical problem the evaluation was poor.

### <Ink Transfer Properties>

A relief printing plate that had been obtained was set in a printer (Model ITM-4, Iyo Kikai Seisakusho Co., Ltd.), as the ink Aqua SPZ16 Red aqueous ink (Toyo Ink Manufacturing Co., Ltd.) was used without dilution, printing was carried out continuously using Full Color Form M 70 (Nippon Paper Industries Co., Ltd., thickness 100 μm) as the printing paper, and the degree of ink attachment in a solid printed area on the printed material at 1,000 m from the start of printing was compared by visual inspection. The evaluation criteria were as follows.
Good: uniform without unevenness in density.
Fair: some unevenness in density but there was no problem in practice.
Poor: unevenness in density.

TABLE 1

| | | (Component B) | | (Component D) | | | Ink |
|---|---|---|---|---|---|---|---|
| | (Component A) | Epoxy resin curing | (Component | Photothermal | | Rinsing | transfer |
| | Epoxy resin | agent | C) Silica | conversion agent | Tg | properties | properties |
| Ex. 1 | EXA-4816 | D-2000 | AEROSIL | Added | Good | Good | Good |
| | | | R202 | | | | |
| Ex. 2 | EXA-4816 | D-400 | AEROSIL | Added | Good | Good | Good |
| | | | R202 | | | | |
| Ex. 3 | EXA-4816 | ED-2003 | AEROSIL | Added | Good | Good | Good |
| | | | R202 | | | | |
| Ex. 4 | EXA-4816 | ED-900 | AEROSIL | Added | Good | Good | Good |
| | | | R202 | | | | |
| Ex. 5 | EXA-4816 | ED-600 | AEROSIL | Added | Good | Good | Good |
| | | | R202 | | | | |
| Ex. 6 | EXA-4816 | Isooctadecenyl | AEROSIL | Added | Good | Good | Good |
| | | succinic anhydride | R202 | | | | |
| Ex. 7 | EXA-4816 | Nonenylsuccinic | AEROSIL | Added | Good | Good | Good |
| | | anhydride | R202 | | | | |
| Ex. 8 | EXA-4816 | DSA | AEROSIL | Added | Good | Good | Good |
| | | | R202 | | | | |
| Ex. 9 | EXA-4816 | PDSA-DA | AEROSIL | Added | Good | Good | Good |
| | | | R202 | | | | |
| Ex. 10 | EXA-4816 | DDSA | AEROSIL | Added | Good | Good | Good |
| | | | R202 | | | | |
| Ex. 11 | EXA-4816 | OSA | AEROSIL | Added | Good | Good | Good |
| | | | R202 | | | | |
| Ex. 12 | EXA-4816 | IPU-22AH | AEROSIL | Added | Good | Good | Good |
| | | | R202 | | | | |
| Ex. 13 | EXA-4850-150 | D-2000 | AEROSIL | Added | Good | Good | Good |
| | | | R202 | | | | |
| Ex. 14 | EPICLON 1050 | D-2000 | AEROSIL | Added | Good | Good | Good |
| | | | R202 | | | | |
| Ex. 15 | EXA-4816 | D-2000 | AEROBIC | Not added | Good | Good | Fair |
| | | | R202 | | | | |
| Comp. | EXA-4816 | Hexamethylene | AEROSIL | Added | Poor | Good | Poor |
| Ex. 1 | | diamine | R202 | | | | |
| Comp. | EXA-4816 | Butylsuccinic | AEROSIL | Added | Poor | Good | Poor |
| Ex. 2 | | anhydride | R202 | | | | |
| Com p. | EXA-4816 | 4-Methylcyclohexane- | AEROSIL | Added | Poor | Good | Poor |
| Ex. 3 | | 1,2-dicarboxylic acid | R202 | | | | |
| | | anhydride | | | | | |
| Comp. | EXA-4816 | D-2000 | OZ-S30 K- | Added | Good | Fair | Poor |
| Ex. 4 | | | AC | | | | |
| Comp. | EXA-4816 | D-2000 | Not added | Added | Good | Poor | Poor |
| Ex. 5 | | | | | | | |

Details of each of the components described in Table 1 are as follows. EXA-4816: epoxy resin, DIC Corporation, viscous liquid at 25° C. D-2000: polypropylene glycol diamine (Mn=2,000), Huntsman, the above compound, amine value 0.0010 eq/g, compound corresponding to Formula (1). D-400: polypropylene glycol diamine (Mn=400), Huntsman, compound in which x in D-2000 above is about 6.1, amine value 0.0047 eq/g, compound corresponding to Formula (1).
ED-2003: polypropylene glycol (PPG)/polyethylene glycol (PEG) diamine (Mn=2,000), Huntsman, the compound below (y is about 39, (x+z) is about 6), amine value 0.0010 eq/g, compound corresponding to Formula (1).

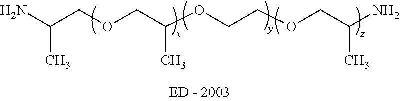

ED-900: PPG/PEG diamine (Mn=900), Huntsman, the compound below (y is about 12.5, (x+z) is about 6), amine value 0.0022 eq/g, compound corresponding to Formula (1).

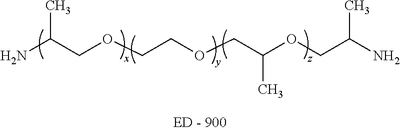

ED-600: PPG/PEG diamine (Mn=600), Huntsman, compound in which y in ED-900 above is about 9 and (x+z) is about 3.6, amine value 0.0033/g, compound corresponding to Formula (1).
Isooctadecenylsuccinic anhydride: alkenylsuccinic anhydride for which R⁴ of Formula (2) is an alkenyl group having 18 carbons, acid anhydride value 0.0029 eq/g.
Nonenylsuccinic anhydride: alkenylsuccinic anhydride for which R⁴ of Formula (2) is an alkenyl group having 9 carbons, acid anhydride value 0.0045 eq/g. DSA: alkenylsuccinic anhydride for which R⁴ of Formula (2) is an alkenyl group having 12 carbons, acid anhydride value 0.0037 eq/g.
PDSA-DA: alkenylsuccinic anhydride for which R⁴ of Formula (2) is an alkenyl group having 15 carbons, acid anhydride value 0.0030 eq/g.
DDSA: alkenylsuccinic anhydride for which R⁴ of Formula (2) is an alkenyl group having 12 carbons, acid anhydride value 0.0037 eq/g.
OSA: alkenylsuccinic anhydride for which R⁴ of Formula (2) is an alkenyl group having 8 carbons, acid anhydride value 0.0048 eq/g.
IPU-22AH: aliphatic dibasic acid polyanhydride, Okamura Oil Mill Co., Ltd., acid anhydride value 0.0035 eq/g, compound corresponding to Formula (3).
EXA-4850-150: epoxy resin, DIC Corporation, viscous liquid at 25° C.
Epiclon 1050: epoxy resin, DIC Corporation, Epiclon series, solid at 25° C., softening point 64° C. to 74° C.
Hexamethylenediamine: amine value 0.017 eq/g
Butylsuccinic anhydride: acid anhydride value 0.0064 eq/g
4-Methylcyclohexane-1,2-dicarboxylic acid anhydride: acid anhydride value 0.0060 eq/g
AEROSIL R202: silica, average primary particle size: 14 nm, Nippon Aerosil Co., Ltd.
OZ-S30K-AC: zirconia sol (Nissan Chemical Industries Ltd., product name: NanoUse)

What is claimed is:

1. A resin composition for laser engraving, comprising:
(Component A) an epoxy resin;
(Component B) an epoxy resin curing agent; and
(Component C) a silica,
Component B comprising an amine curing agent having an amine value of no greater than 0.01 eq/g or an acid anhydride curing agent having an acid anhydride value of no greater than 0.0050 eq/g.

2. The resin composition for laser engraving according to claim 1, wherein the amine curing agent is a diamine compound having a polyalkyleneoxy chain.

3. The resin composition for laser engraving according to claim 1, wherein the acid anhydride curing agent is an alkylsuccinic anhydride, an alkenylsuccinic anhydride, or an aliphatic dibasic acid polyanhydride.

4. The resin composition for laser engraving according to claim 2, wherein the acid anhydride curing agent is an alkylsuccinic anhydride, an alkenylsuccinic anhydride, or an aliphatic dibasic acid polyanhydride.

5. The resin composition for laser engraving according to claim 1, wherein Component B is a diamine represented by Formula (1),
H₂N—R¹R²—OₙR³—NH₂ (1)
wherein in Formula (1), R¹ denotes a single bond or a divalent hydrocarbon group having 1 to 20 carbons, the R²s independently denote a divalent hydrocarbon group having 2 to 20 carbons, R³ denotes a divalent hydrocarbon group having 2 to 20 carbons, and n denotes an integer of 1 or greater, the diamine represented by Formula (1) having an amine value of no greater than 0.01 eq/g due to the structures of R¹ to R³ and the number denoted by n.

6. The resin composition for laser engraving according to claim 1, wherein Component B is an alkenylsuccinic anhydride or an aliphatic dibasic acid polyanhydride.

7. The resin composition for laser engraving according to claim 1, wherein Component B is an anhydride represented by Formula (2), 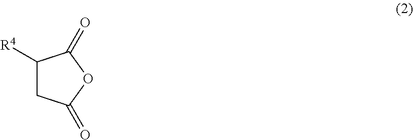
wherein in Formula (2), R⁴ denotes a hydrocarbon group having 8 to 30 carbons.

8. The resin composition for laser engraving according to claim 1, wherein Component B is an aliphatic dibasic acid polyanhydride represented by Formula (3), 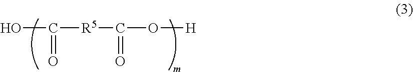
wherein in Formula (3), R⁵ denotes a divalent hydrocarbon group having 9 to 30 carbons and m denotes an integer of 2 or greater.

9. The resin composition for laser engraving according to claim 1, wherein Component B is a diamine represented by Formula (1), an anhydride represented by Formula (2), or an aliphatic dibasic acid polyanhydride represented by Formula (3), 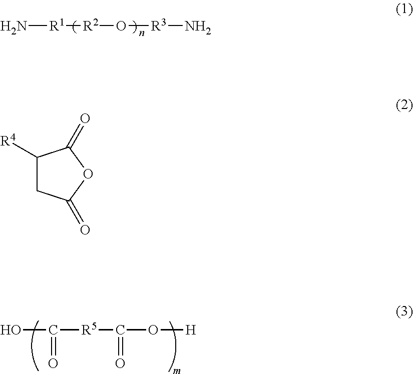
wherein in Formulae (1) to (3), R¹ denotes a single bond or a divalent hydrocarbon group having 1 to 20 carbons, the R²s independently denote a divalent hydrocarbon group having 2 to 20 carbons, R³ denotes a divalent hydrocarbon group having 2 to 20 carbons, n denotes an integer of 1 or greater, the diamine represented by Formula (1) having an amine value of no greater than 0.01 eq/g due to the structures of R¹ to R³ and the number denoted by n, R⁴ denotes a hydrocarbon group having 8 to 30 carbons, R⁵ denotes a divalent hydrocarbon group having 9 to 30 carbons, and m is an integer of 2 or greater.

10. The resin composition for laser engraving according to claim 1, wherein Component C has an average particle size of no greater than 100 nm.

11. The resin composition for laser engraving according to claim 1, wherein Component C has an average particle size of 3 to 60 nm.

12. The resin composition for laser engraving according to claim 1, wherein it further comprises (Component D) a photothermal conversion agent.

13. The resin composition for laser engraving according to claim 1, wherein Component A is a plastomer at 25° C.

14. The resin composition for laser engraving according to claim 1, wherein the content of Component B is higher than the content of Component A.

15. A flexographic printing plate precursor comprising a relief-forming layer comprising the resin composition for laser engraving according to claim 1.

16. A flexographic printing plate precursor comprising a crosslinked relief-forming layer formed by crosslinking by means of heat a relief-forming layer comprising the resin composition for laser engraving according to claim 1.

17. A process for producing a flexographic printing plate precursor, comprising:
a layer formation step of forming a relief-forming layer comprising the resin composition for laser engraving according to claim 1; and
a crosslinking step of crosslinking the relief-forming layer by means of heat to thus obtain a flexographic printing plate precursor comprising a crosslinked relief-forming layer.

18. A process for making a flexographic printing plate, comprising:
an engraving step of laser-engraving the crosslinked relief-forming layer of the flexographic printing plate precursor according to claim 16.

19. A flexographic printing plate comprising a relief layer made by the process for making a flexographic printing plate according to claim 18.
